(19) United States
(12) Patent Application Publication
(10) Pub. No.: US 2013/0320027 A1
(43) Pub. Date: Dec. 5, 2013

(54) COLD DRINK CUP

(71) Applicant: Alejandro Casillas, Denver, CO (US)

(72) Inventor: Alejandro Casillas, Denver, CO (US)

(21) Appl. No.: 13/481,956

(22) Filed: May 29, 2012

(51) Int. Cl. A47J 41/00

(52) U.S. Cl. 220/592.17

(57) ABSTRACT

The present invention is a cold drink cup that includes a base cup with a top portion with a raised portion and a side, an interior opening that is disposed on the top portion of the base cup and a hollow interior portion that surrounds the interior opening and contains cooling water to cool the interior opening. The cold drink cup also includes an aperture that is disposed on the raised portion of the top portion above the hollow interior portion that receives the cooling water to cool the interior opening, an aperture cap that is removably placed on the aperture to prevent cooling water from spilling out of the hollow interior portion and a handle that is disposed on the side of the base cup and is grasped by a user to facilitate drinking the drink contained in the cup.

### TECHNICAL FIELD & BACKGROUND

Traditional methods for cooling a drink can include adding ice directly into the drink. This can be unsanitary if an individual utilizes his or her hands to procure the ice and often dilutes the drink when the ice begins to melt, thereby changing the taste of the drink.

The present invention generally relates to a cup. More specifically, the invention is a cold drink cup.

It is an object of the invention to provide a cold drink cup that keeps a drink cold without adding ice directly into the drink.

It is an object of the invention to provide a cold drink cup that is reusable for a plurality of different types of drinks.

It is an object of the invention to provide a cold drink cup that is relatively more sanitary to use than a traditional cold drink cup.

What is really needed is a cold drink cup that keeps a drink cold without adding ice directly into the drink that is reusable for a plurality of different types of drinks that is relatively more sanitary to use than a traditional cold drink cup.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side view of a cold drink cup, according to an embodiment of the present invention.

FIG. 1B illustrates a cross-sectional view along line 1A-1A from FIG. 1A of a cold drink cup, according to an embodiment of the present invention.

FIG. 1C illustrates a top view of a cold drink cup, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

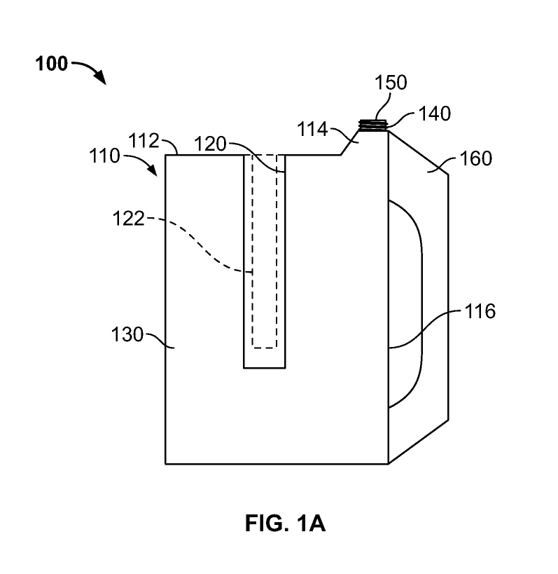

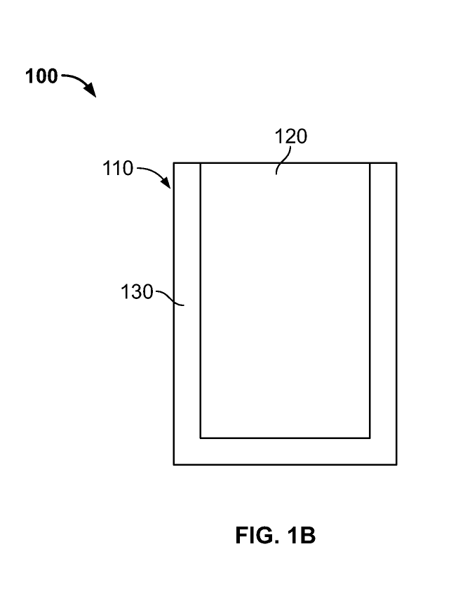

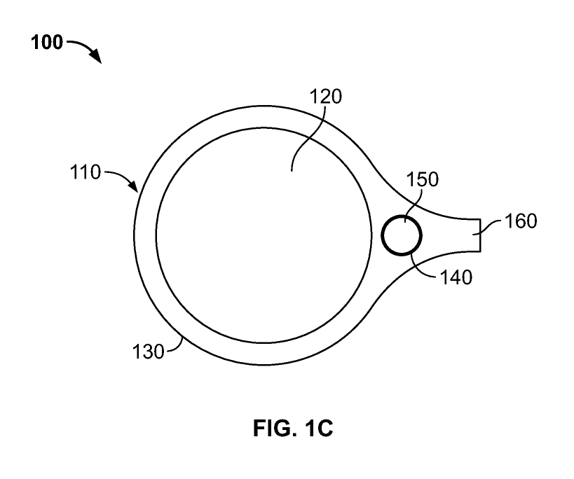

FIG. 1A illustrates a side view of a cold drink cup 100, according to an embodiment of the present invention. The cold drink cup 100 can be mug-shaped 102 or any other suitable shape.

The cold drink cup 100 includes a base cup 110, an interior opening 120, a hollow interior portion 130, an aperture 140, an aperture cap 150 and a handle 160. The base cup 110 has a top portion 112 with a raised portion 114 and a side 116. The interior opening 120 is disposed on the top portion 112 of the base cup 110 to accommodate and contain a cup 122. The hollow interior portion 130 surrounds the interior opening 120 and contains cooling water or any other suitable liquid to cool the interior opening 120 and the cup 122. The hollow interior portion 130 is approximately 1 inch in width but can be other suitable widths as well. The aperture 140 is disposed on the raised portion 116 of the top portion 112 above the hollow interior portion 130 that receives the cooling water or other suitable liquid to cool a drink contained in the cup 122 or be frozen to provide additional cooling capacity. The cooling water is typically frozen by placing the cold drink cup 100 and cooling water into a freezer or other suitable freezing device. The aperture cap 150 is removably placed on the aperture 140 to prevent cooling water from spilling out of the hollow interior portion 130. The handle 160 is disposed on the side 116 of the base cup 110 and is grasped by a user to facilitate drinking the drink contained in the cup 122.

FIG. 1B illustrates a cross-sectional view along line 1A-1A from FIG. 1A of a cold drink cup 100, according to an embodiment of the present invention. FIG. 1B illustrates and describes a similar cold drink cup 100, base cup 110, interior opening 120 and hollow interior portion 130 that is illustrated and described in FIG. 1A.

FIG. 1C illustrates a top view of a cold drink cup 100, according to an embodiment of the present invention. FIG. 1C illustrates and describes a similar cold drink cup 100, base cup 110, interior opening 120, hollow interior portion 130, aperture 140, aperture cap 150 and handle 160 that is illustrated and described in FIG. 1A.

The cold drink cup is a hollow cup capable of retaining cold temperatures and is a well-suited alternative to current similar cold drink cups. Easy to use, the cold drink cup contains a capped aperture which is designed to be filled with water or other suitable liquid. Once the water has been poured into the hollow interior portion, the aperture is sealed and the cold drink cup is placed within a freezer until the water in the hollow interior portion of the cup becomes solid and the container filled with the desired drink is placed within the cold drink cup, successfully cooling a beverage contained in the cup. Among those who will find the cold drink cup both convenient and practical are restaurants, bars and an everyday consumer. The cold drink cup features a reusable cup made of plastic or one or more other suitable insulating materials which effectively cool a drink without the need to add ice directly into the beverage contained in the cold drink cup. The cold drink cup is designed with an opening at the side, allowing for a cup with a handle to be properly inserted and fastened.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A cold drink cup, comprising:
a base cup with a top portion with a raised portion and a side;
an interior opening that is disposed on said top portion of said base cup;
a hollow interior portion that surrounds said interior opening and contains cooling water;
an aperture that is disposed on said top portion above said hollow interior portion that receives said cooling water to cool said interior opening;
an aperture cap that is removably placed on said aperture to prevent cooling water from spilling out of said hollow interior portion; and
a handle that is disposed on said side of said base cup and is grasped by a user to facilitate drinking a drink contained in a cup.

2. The cold drink cup according to claim 1, wherein said interior opening accommodates and contains said cup with said drink.

3. The cold drink cup according to claim 1, wherein said cooling water cools said cup and said drink.

4. The cold drink cup according to claim 1, wherein said cooling water is frozen to provide additional cooling capacity.

5. The cold drink cup according to claim 1, wherein said cooling water cooling water is frozen by placing said cold drink cup into a freezer.

6. The cold drink cup according to claim 1, wherein said cold drink cup is made of insulating material.

7. A cold drink cup, comprising:
a base cup with a top portion with a raised portion and a side;
an interior opening that is disposed on said top portion of said base cup;
a hollow interior portion that surrounds said interior opening and contains cooling water;
an aperture that is disposed on said raised portion of said top portion above said hollow interior portion that receives said cooling water to cool said interior opening;
an aperture cap that is removably placed on said aperture to prevent cooling water from spilling out of said hollow interior portion; and
a handle that is disposed on said side of said base cup and is grasped by a user to facilitate drinking a drink contained in a cup.

8. The cold drink cup according to claim 7, wherein said interior opening accommodates and contains said cup with said drink.

9. The cold drink cup according to claim 7, wherein said cooling water cools said cup and said drink.

10. The cold drink cup according to claim 7, wherein said cooling water is frozen to provide additional cooling capacity.

11. The cold drink cup according to claim 7, wherein said cooling water cooling water is frozen by placing said cold drink cup into a freezer.

12. The cold drink cup according to claim 7, wherein said cold drink cup is made of insulating material.

13. A mug-shaped cold drink cup, comprising:
a base cup with a top portion with a raised portion and a side;
an interior opening that is disposed on said top portion of said base cup;
a hollow interior portion that surrounds said interior opening and contains cooling water;
an aperture that is disposed on said raised portion of said top portion above said hollow interior portion that receives said cooling water to cool said interior opening;
an aperture cap that is removably placed on said aperture to prevent cooling water from spilling out of said hollow interior portion; and
a handle that is disposed on said side of said base cup and is grasped by a user to facilitate drinking a drink contained in a cup.

14. The cold drink cup according to claim 13, wherein said interior opening accommodates and contains said cup with said drink.

15. The cold drink cup according to claim 13, wherein said cooling water cools said cup and said drink.

16. The cold drink cup according to claim 13, wherein said cooling water is frozen to provide additional cooling capacity.

17. The cold drink cup according to claim 13, wherein said cooling water cooling water is frozen by placing said cold drink cup into a freezer.

18. The cold drink cup according to claim 13, wherein said hollow interior portion is approximately 1 inch in width.

19. The cold drink cup according to claim 13, wherein said cold drink cup is made of insulating material.

20. The cold drink cup according to claim 13, wherein said cold drink cup is made of plastic material.
